(19) United States
(12) Patent Application Publication
(10) Pub. No.: US 2012/0202056 A1
(43) Pub. Date: Aug. 9, 2012

(54) COMPOSITE MATERIALS HAVING GRAPHENE LAYERS AND PRODUCTION AND USE THEREOF

(75) Inventors: Aurel Wolf, Wulfrath (DE); Giulio Lolli, Koln (DE); Leslaw Mleczko, Dormagen (DE); Oliver Felix-Karl Schlüter, Leverkusen (DE)

(73) Assignee: BAYER TECHNOLOGY SERVICES, Leverkusen (DE)

(21) Appl. No.: 13/498,819

(22) PCT Filed: Oct. 11, 2010
(86) PCT No.: PCT/EP2010/065190

§ 371 Date: Apr. 30, 2012

(30) Foreign Application Priority Data
Oct. 15, 2009 (DE) 10 2009 049 379.4

(51) Int. Cl. B32B 9/04; C01B 31/02; B05D 3/02; B82Y 40/00; B82Y 30/00

(52) U.S. Cl. 428/336; 423/448; 428/408; 428/446; 428/697; 427/228; 977/734; 977/845

(57) ABSTRACT

The present invention relates to composites having graphene layers and also processes for producing these composites. The invention further relates to a process for producing graphene layers using the composites of the invention.

The present invention relates to composites having graphene layers and also processes for producing these composites. The invention further relates to a process for producing graphene layers using the composites of the invention.

Graphenes are two-dimensional carbon crystals having a structure analogous to single graphite layers. The carbon atoms are arranged in a hexagonal honeycomb structure. This arrangement results from the hybridization of the 2s, 2px and 2py orbitals of the participating carbon atoms to form sp² hybrid orbitals. Graphene has metallic and nonmetallic properties. Metallic properties of graphene are the good electrical and thermal conductivity. The nonmetallic properties give a high thermal stability, chemical inertness and ability of these compounds to act as lubricants. One possible way of making these materials available in industrial applications is to integrate graphene into composites. The production of such composites makes it necessary not only for graphene to be produced in sufficient amounts, but also for the material to be able to be introduced into other materials in a homogeneously distributed manner.
Stankovich et al. [Nature, Vol. 442, July 2006] describes the production of a graphene composite by exfoliation of graphite and dispersion of individual, chemically modified graphene layers in polystyrene.
US2007/0158618A1 describes the production of graphene nanocomposites by exfoliation of graphite and comminution of the resulting material by means of a ball mill and subsequent mixing of these graphene layers with polymers.
US2007/0092716A1 discloses the production of a graphene composite, in which nanographene layers are mixed with polymeric material and, for example, extruded in the form of fibres.

A disadvantage of the known processes for producing graphene composites is, in particular, the difficulty of being able to set the thickness of the graphene layers in the composite precisely and to integrate graphene layers having a thickness of significantly less than 20 nm. This difficulty is firstly associated with the fact that the graphene layers used can partially aggregate during the production process before formation of the composite and is secondly due to the great difficulty of producing graphene layers having a thickness of significantly less than 20 nm by means of the known processes for producing graphene layers (for example mechanical or chemical exfoliation methods).

However, graphene layers having a thickness of significantly less than 20 nm have, when used in a composite, the advantage over graphene layers having a thickness of about 20 nm that, for example, the percolation threshold (molar concentration leading directly to a reduction in the electrical resistance within the composite) is significantly reduced. When individual graphene layers (0.335 nm) are used, the percolation threshold is less than 0.1% by weight [Stankovich et al. Nature, Vol. 442, July 2006]. In comparison, percolation thresholds of 3-5% by weight have been described when using graphene layers having a thickness of about 20 nm.

The present invention addresses the disadvantages of the prior art and has the object of providing composites having graphene layers which have a thickness of significantly less than 20 nm.

A further object of the present invention is to give fillers known per se, e.g. sheet silicates or layered double hydroxides, which do not have electrical or thermal conductivity such properties.

The objects are achieved by provision of a composite of sheet silicate or layered double hydroxides and polyacrylonitrile which has been at least partially decomposed into graphene layers and has a relative proportion by mass of nitrogen of less than 20% based on the relative molecular mass of polyacrylonitrile.

Apart from provision of a composite containing graphene layers having a thickness of significantly less than 20 nm, the composite of the invention also combines the advantages of graphene layers (mechanical and electrical conductivity) with the advantageous properties of sheet silicates or layered double hydroxides (insulation and filler function) in one material. The composites of the invention offer the further advantage that the nature of the material is similar to that of sheet silicates or layered double hydroxides, which means that the composites of the invention can also be used for known processes and methods in which sheet silicates or layered double hydroxides are at present used as starting materials.

The sheet silicates which can be used according to the invention are the silicate structures known from the prior art which have two-dimensional layers of SiO₄ tetrahedra (also referred to as phyllosilicates). Examples of suitable sheet silicates are bentonite, talc, pyrophyllite, mica, serpentine, kaolinite or mixtures thereof. The sheet silicates can be modified by known methods in order to alter the layer spacing. For this purpose, for example, ammonium compounds having at least one acid group are intercalated between the layers [DE10351268A1]. The intercalation is effected by replacement of the cations present in the layer lattice of the silicates by the ammonium compounds having at least one acid group and generally leads to a widening of the layer spacing. Sheet silicates or the sheet silicates modified by the above-described process preferably have a layer spacing of from 0.5 to 2.5 nm and even more preferably from 0.7 to 1.5 nm.

Layered double hydroxides (LDH) are compounds which have the general formula

[M²⁺₁₋ₓN³⁺ₓ(OH)₂][Aⁿ⁻]_{x/n}.yH₂O. Here, M²⁺ is a divalent alkaline earth or transition metal ion such as Mg²⁺, Ni²⁺, Cu²⁺ or Zn²⁺, N³⁺ is a trivalent main group or transition metal ion such as Al³⁺, Cr³⁺, Fe³⁺ or Ga³⁺, Aⁿ⁻ is an anion such as NO₃⁻, CO₃²⁻, Cl⁻ or SO₄²⁻, x is a rational number from 0 to 1 and y is a positive number including 0. According to the invention, the term “layered double hydroxides” also encompasses the oxides of these compounds. According to the invention, preference is given to using natural and synthetic hydrotalcites and compounds having a hydrotalcite-like structure (hydrotalcite-like compounds, HTLC) as layered double hydroxides. To prepare the hydrotalcites or the compounds having a hydrotalcite-like structure, it is in principle possible to use any process with which those skilled in the art are familiar [see, for example, those described in the above reference: DE 2061114A, U.S. Pat. No. 5,399,329A, U.S. Pat. No. 5,578,286A, DE 10119233, WO 0112570, Handbook of Clay Science, F. Bergaya, B. K. G. Theng and G. Lagaly, Developments in Clay Science, Vol. 1, Chapter 13.1, Layered Double Hydroxides, C. Forano, T. Hibino, F. Leroux, C. Taviot-Gueho, Handbook of Clay Science, 2006].

Preference is given according to the invention to the use of a hydrotalcite of the general (nominal) formula M₂ₓ²⁺M₂³⁺(OH)₄ₓ₊₄.A_{2/n}ⁿ⁻.zH₂O, where M₂ₓ²⁺ is a divalent metal selected from the group consisting of Mg, Zn, Cu, Ni, Co, Mn, Ca and/or Fe. M₂³⁺ is a suitable trivalent metal selected from the group consisting of Al, Fe, Co, Mn, La, Ce and/or Cr. “x” is a number from 0.5 to 10 in intervals of 0.5. A is an interstitial anion. Suitable anions are organic anions such as alkoxides, alkyl ether sulphates, aryl ether sulphates and/or glycol ether sulphates or inorganic anions such as carbonates, hydrogencarbonates, nitrates, chlorides, sulphates, B(OH)₄⁻ and/or polyoxometalate ions such as Mo₇O₂₄⁶⁻ or V₁₀O₂₈⁶⁻. Particular preference is given to using CO₃²⁻ and NO₃⁻. “n” in the abovementioned general formula is the charge on the interstitial anion, which can be up to 8 and normally up to 4. “z” is an integer from 1 to 6, preferably from 2 to 4. The corresponding metal oxide, which can be obtained by calcination and is present in the composite of the invention, has the general formula M₂ₓ²⁺M₂³⁺(O)_{(4x+4)/2}, where M₂ₓ²⁺, M₂³⁺ and “x” are as defined above. It is known to those skilled in the art that such materials can, in particular when in contact with water, be present in a partially hydroxylated form. The hydrotalcites which are preferred according to the invention and are described in this section and their preparation have been described, for example, in U.S. Pat. No. 6,514,473B2.

According to the invention, preference is given to using layered double hydroxides and particularly preferably hydrotalcites having a layer spacing of from 0.5 to 2.5 nm and preferably from 0.7 to 1.5 nm. The layer spacing can be increased artificially as in the case of the sheet silicates by using suitable intercalating agents. Anions such as 3-aminobenzenesulphonic acid, 4-toluenesulphonic acid monohydrate, 4-hydroxybenzenesulphonic acid, dodecylsulphonic acid, terephthalic acid are in principle suitable for this purpose [Zammarano et al., Polymer Vol. 46, 2005, pp. 9314-28; U.S. Pat. No. 4,774,212]. A person skilled in the art will be familiar with other anions. For the purposes of the present compound, the anions used are not critical. The anions serve exclusively to modify the layers of the layered double hydroxides. They decompose during the thermal treatment in the production process for the composites of the invention.

Particularly suitable hydrotalcites are marketed by Sasol Deutschland GmbH under the trade name Pural.

According to the invention, mainly graphene layers formed by polymerization and calcination of acrylonitrile during the production process for the composite are present in the layers of the sheet silicate or the layered double hydroxides.

U.S. Pat. No. 4,921,681 discloses a composite comprising montmorillonite (a sheet silicate) and partially carbonized polyacrylonitrile as intermediate for producing highly oriented pyrolitic graphite (HOPG). In example 1, carbonization is carried out at 700° C. for 3 hours. According to the prior art [Peter Morgan, Carbon fibres and their composites; Vol. 27; CRC Press, 2005; p. 2235], such an intermediate has a relative proportion by mass of nitrogen of at least 20% based on the relative molecular mass of polyacrylonitrile. The relative proportion by mass of nitrogen of polyacrylonitrile (i.e. the starting material) is 26%. The composite claimed according to the invention is distinguished by the relative proportion by mass of nitrogen being less than 20%, preferably less than 15%, even more preferably equal to or less than 10%, even more preferably equal to or less than 5% and even more preferably equal to or less than 3%, based on the relative molecular mass of polyacrylonitrile. The nitrogen-containing material according to the invention does not have an HOPG structure but rather relates to graphene layer structures having a layer thickness of from 0.5 to 2.5 nm. The determination of the proportion by mass of nitrogen can be carried out by the known and established standard method ICP-MS (mass spectrometry with inductively coupled plasma), for example by an analytical laboratory certified in accordance with DIN-ISO 17025.

However, when exclusive use is made of a layered double hydroxide for the composite of the invention, the relative proportion by mass of nitrogen based on the relative molecular mass of polyacrylonitrile can be 20% or even more than 20%. However, the abovementioned, preferred values for the relative proportions by mass of nitrogen are preferred even in this case.

According to the invention, the reduction in the relative proportion of nitrogen is achieved by increasing the calcination temperature appropriately. For example, to obtain a proportion by mass of nitrogen of equal to or less than 10%, calcination at 1000° C. for at least 40 minutes, preferably at least 90 minutes and more preferably at least 2 hours, in a conventional oven is necessary (taking into account the maximum loading capacity of the oven).

The expression “polyacrylonitrile which has been at least partially decomposed into graphene layers” describes the carbonization of polyacrylonitrile to graphene layers by the calcination step described in the present patent application. However, depending on the temperature and duration of the calcination step, the polyacrylonitrile may not be completely decomposed or carbonized but instead polyacrylonitrile or only partially decomposed polyacrylonitrile is present in the composite of the invention. The temperature has a direct influence on the carbon/nitrogen ratio. The thermal treatment has to be carried out for a particular time in order for virtually all compounds to be removed to be able to be conveyed by diffusion to the outside (outside the composite) and for the compounds within the composite to be able to rearrange to an equilibrium state. To ensure this, calcination has to be carried out for at least a time of 10 minutes, preferably at least 40 minutes and even more preferably at least 90 minutes, in a conventional oven or at least 5 minutes and more preferably at least 45 minutes in a microwave oven. The maximum loading capacity of the oven has to be taken into account and adhered to. The decomposition process of polyacrylonitrile into graphene layers is known and has been described, for example, by Fitzer et al. [Carbon Vol. 24, Issue 4, 1986, pp. 387-395]. Degradation products formed by the decomposition of polyacrylonitrile are, for example, H₂, N₂, NH₃ and HCN.

The decomposition of polyacrylonitrile into graphene layers is accordingly dependent essentially on the calcination temperature selected. A preferred embodiment of the invention provides a composite in which the polyacrylonitrile has decomposed to an extent of 95%, preferably 98%, even more preferably 99% and very particularly preferably completely, into graphene layers. Temperatures above 1600° C. are necessary for this (at least 95% decomposition). Complete decomposition (i.e. at least 99% decomposition) is achieved using temperatures of about 2000° C. The calcination step is preferably carried out under an inert atmosphere (argon or nitrogen, preferably Ar) and at atmospheric pressure.

For the purposes of the invention, the term “calcination” refers generally to a thermal treatment step, i.e. heating of a material with the aim of decomposing this material. The material which is to be decomposed into graphene layers is, according to the invention, polyacrylonitrile.

The term “graphene layers” refers to two-dimensional carbon crystals which have a structure analogous to single graphite layers and whose carbon atoms are arranged in a hexagonal honeycomb structure with formation of sp² hybrid orbitals. A single graphene layer has a thickness of 0.335 nm. At a layer spacing of the sheet silicates or layered double hydroxides of preferably from 0.5 to 2.5 nm, from 1 to 7 graphene layers can accordingly be present within a single layer.

The preparation of polyacrylonitrile from acrylonitrile is known and has been comprehensively described, for example, in connection with the synthesis of carbon fibres [U.S. Pat. No. 3,681,023; U.S. Pat. No. 4,397,831].

The invention further provides a composite of layered double hydroxides and preferably of hydrotalcite and/or a compound having a hydrotalcite-like structure and polyacrylonitrile which has been at least partially decomposed into graphene layers.

The invention also provides a process for producing composites having graphene layers, in which acrylonitrile is added to a layered double hydroxide or sheet silicate in a first step so that the acrylonitrile can become incorporated within the layer structure of the layered double hydroxide or sheet silicate, the acrylonitrile within the layer structure is polymerized to polyacrylonitrile in a second step and the polyacrylonitrile is subsequently at least partially decomposed into graphene layers by calcination so as to form a composite having a relative proportion by mass of nitrogen of less than 20% based on the relative molecular mass of polyacrylonitrile. The invention further provides a process for producing composites having graphene layers, in which acrylonitrile is added to a layered double hydroxide in a first step so that the acrylonitrile can become incorporated within the layer structure of the layered double hydroxide, the acrylonitrile within the layer structure is polymerized to polyacrylonitrile in a second step and the polyacrylonitrile is subsequently at least partially decomposed into graphene layers by calcination.

In the production processes according to the invention, the acrylonitrile is preferably added dropwise to the layered double hydroxide or the sheet silicate. The layered double hydroxide or the sheet silicate is preferably present as powder and is preferably dried so that very little moisture is present before the addition of acrylonitrile. Suitable preferred and particularly preferred layered double hydroxides or sheet silicates have been described in detail further above in the patent application. Preference is given to using layered double hydroxides for the production process. In the first step of the production process, the hydroxides or oxides of the layered double hydroxides can be used. The oxides are preferably used for the production process.

In a preferred embodiment of the invention, a polymerization initiator is added to the acrylonitrile before addition to the layered double hydroxide or the sheet silicate in order to aid the polymerization of the acrylonitrile. Suitable polymerization initiators for acrylonitrile are known to those skilled in the art. Examples of suitable polymerization initiators are azo compounds, peroxides and/or light and high-energy radiation. Possible initiators are, for example: tert-butyl peroctoate, benzoyl peroxide, dilauroyl peroxide, tert-butyl perpivalate, azobis(isobutyronitrile), di-tert-butylperoxy-3,3,5-trimethylcyclohexane, di-tert-butylperoxy hexahydroterephthalate, 2,5-dimethylhexane 2,5-diperbenzoate, t-butyl per-2-ethylhexanoate, azobis(2,4-dimethylvaleronitrile), 2,5-dimethyl-2,5-di(tert-butylperoxy)hexane, dioctanoyl peroxide, t-butyl perneodecanoate, diisopropyl peroxydicarbonate. The polymerization can also be triggered by means of light and photoinitiators.

The mixing ratio of acrylonitrile to the layered double hydroxide or sheet silicate is preferably selected so that the layered double hydroxide or the sheet silicate is completely saturated with the acrylonitrile. When a suitable mixing ratio is chosen and layered double hydroxides or sheet silicates are used as powders, the acrylonitrile can become incorporated in the layer structure when the powder is completely moist.

In a second production step, the acrylonitrile within the layer structure of the layered double hydroxide or the sheet silicate is polymerized to polyacrylonitrile. The polymerization can be initiated by various methods known to those skilled in the art. For example, the polymerization can be initiated by means of ionizing radiation [U.S. Pat. No. 3,681,023]. When a polymerization initiator such as benzoyl peroxide is used, the polymerization of acrylonitrile can be started and carried out by addition of this and preferably by gentle heating to temperatures in the range from 50° C. to 100° C. and preferably under oxidizing conditions. The reaction is preferably carried out for a period of from 2 to 3 hours. The invention therefore further provides a process for producing composites having graphene layers, in which acrylonitrile is added together with a polymerization initiator to a layered double hydroxide or to the sheet silicate.

In a third production step, the polymerized acrylonitrile present in the layers of the layered double hydroxide or the sheet silicate is decomposed or carbonized at least partially to form graphene layers by calcination. This third step firstly comprises stabilization of the polyacrylonitrile (i.e. ring formation and crosslinking) and is carried out at temperatures of from 200 to 500° C., preferably under oxidizing conditions and preferably stepwise. The crosslinked polyacrylonitrile is then decomposed or carbonized by being heated to temperatures of at least 700° C. (if only layered double hydroxides are used for producing the composite of the invention), otherwise preferably at least 800° C., more preferably 900° C., particularly preferably 1000° C. and even more preferably to temperatures of from 1600° C. to 2000° C. and very particularly preferably to temperatures of 2000° C., preferably under a stream of inert gas, i.e. nonoxidizing conditions. The duration of the calcination is dependent, inter alia, on the amount to be calcined. Calcination is preferably carried out for a period of 10 minutes, preferably at least 40 minutes and even more preferably at least 90 minutes, in a conventional oven or at least 5 minutes and preferably at least 45 minutes in a microwave oven.

The invention further provides a process for producing composites having graphene layers, in which the calcination step comprises a temperature increase, in particular a stepwise temperature increase, to from 200° C. to 500° C. to stabilize the polyacrylonitrile and a subsequent temperature increase to at least 700° C. (if only layered double hydroxides are used) and preferably to at least 800° C. to at least partially decompose polyacrylonitrile into graphene layers.

The invention additionally provides a composite having graphene layers which has been produced by a process according to the invention for producing composites having graphene layers.

In addition, it has surprisingly been found that the composites of the invention are suitable for producing graphene layers of preferably from 0.5 nm to 2.5 nm (i.e. from 1 to 7 graphene layers), and more preferably from 0.7 nm to 1.5 nm (i.e. from 2 to 4 graphene layers). For this purpose, the composite of the invention is treated with an acid or an alkali. Suitable acids are, for example, hydrofluoric acid, hydrochloric acid, nitric acid or sulphuric acid. Suitable alkalis are, for example, sodium hydroxide, potassium hydroxide and salts such as ammonium fluoride. Other acids and alkalis which can be used are known to those skilled in the art. It is also possible to use a plurality of acids or a plurality of alkalis simultaneously or in succession.

This production process for graphene layers overcomes the known disadvantages in respect of the low yield of graphene obtained by the known graphene production processes via gas-phase deposition [Xianbao Wang et al., Chem. Vap. Deposition Vol. 15, 2009, pp. 53-56]. In this known process, the yield of graphene when using one gram of catalyst is 0.1 gram. This is very low compared to the production of carbon nanotubes by gas-phase deposition, in which yields of 200-300 gram of carbon nanotubes per gram of catalyst used are obtained. The yield can be increased by the present process.

A further advantage of the production process of the invention for graphene layers is the low layer thicknesses which can be produced by this process.

The present invention additionally provides for the use of a composite according to the invention for producing graphene layers.

### FIGURES

FIG. 1: Graphene layers within the layer structure of the hydrotalcite material Pural MG 70. The alternating layers of metal oxide (dark) and the graphene layers (lighter) can be seen.

FIG. 2: Graphene layers within the layer structure of the hydrotalcite material Pural MG 63.

FIG. 3: Pural MG70 hydrotalcite starting material.

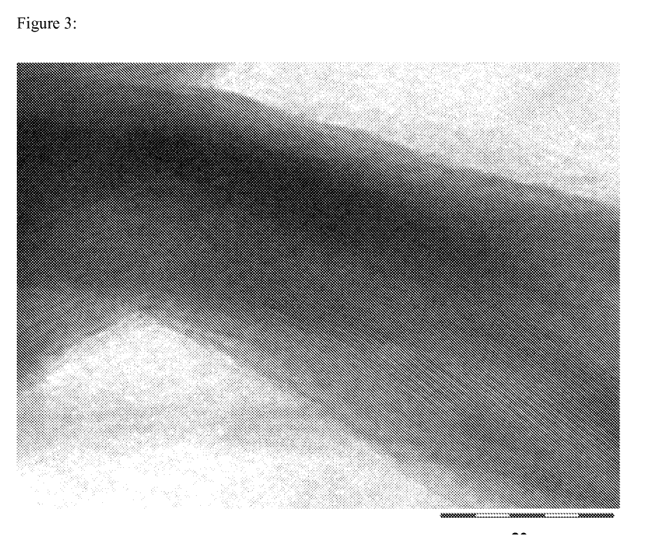

FIG. 4: FIG. 4 shows an enlarged section of the aforementioned FIG. 1.

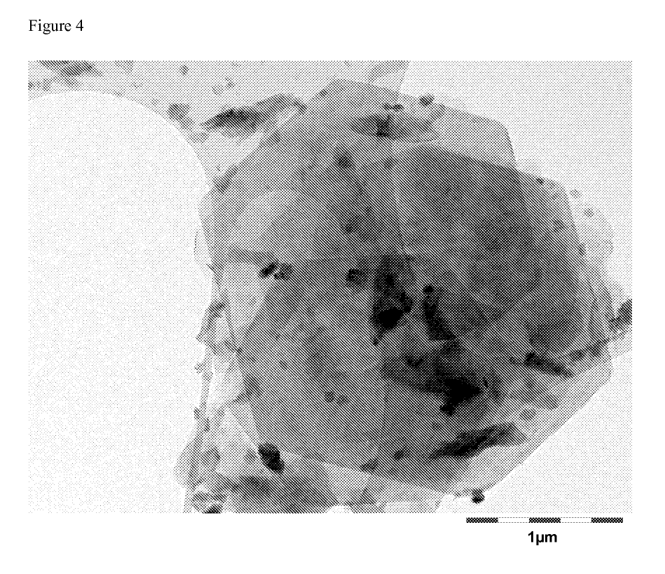

### EXAMPLES

### Example 1

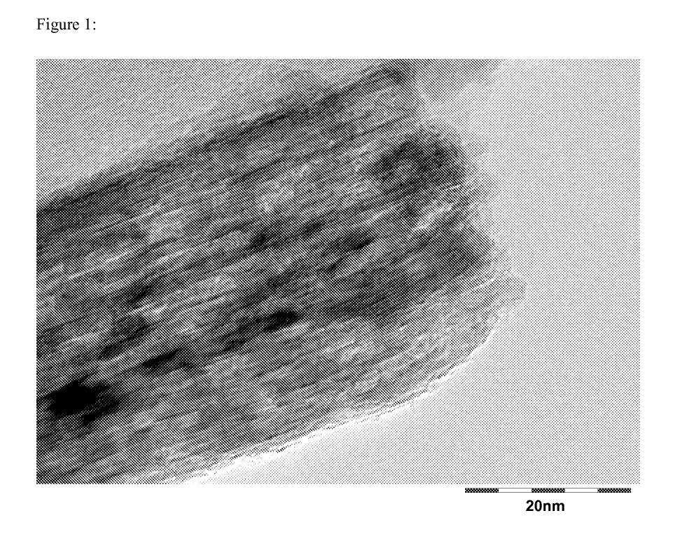

10 g of Pural MG70 hydrotalcite from Sasol Deutschland GmbH were dried at 70° C. in an oven in order to reduce excess moisture. This hydrotalcite material has a nominal chemical composition of 70% by weight of MgO and 30% by weight of Al₂O₃, packed in a layer structure having a spacing of 0.7 nm between the individual layers. 5 ml of acrylonitrile were then admixed with 10 mg of benzoyl peroxide, with the benzoyl peroxide dissolving rapidly. This solution was then added dropwise to the hydrotalcite and the mixture was stirred until a homogeneous mixture had been formed. At a suitable mixing ratio of liquid and solid (in the present experiment, 0.5 ml of acrylonitrile per 1 g of hydrotalcite), a “moist” powder in which the acrylonitrile has become incorporated in the layer structure of the hydrotalcite is obtained. This powder is subsequently introduced into a suitable closable vessel and heated at 70° C. for 3 hours in an oven. The acrylonitrile polymerizes to polyacrylonitrile within the layers of the hydrotalcite support. The polymerization initiator is decomposed during this process. The colour of the material changes from white to pale yellow as a result of the polymerization. The air temperature is then increased to 300° C. During this step, the polyacrylonitrile is crosslinked. Rings similar to aromatic rings are formed. This step is referred to as stabilization of the polyacrylonitrile in the terminology of carbon fibre production. The stabilized polyacrylonitrile/hydrotalcite composite is dark brown. In the subsequent step, the polyacrylonitrile is then carbonized at 1000° C. under a stream of argon in a fused silica furnace. The material is maintained at these temperatures for two hours. This results in a composite of graphene and hydrotalcite which due to its carbon content appears dark gray. Transmission electron micrographs of the composite (see FIG. 1) at low resolution (top left, small picture) show the hexagonal platelet structures typical of the hydrotalcite material and at high resolution (bottom right, large picture) show the alternating layer structures of dense metal oxide (dark regions) and less dense graphene (light regions).

### Example 2

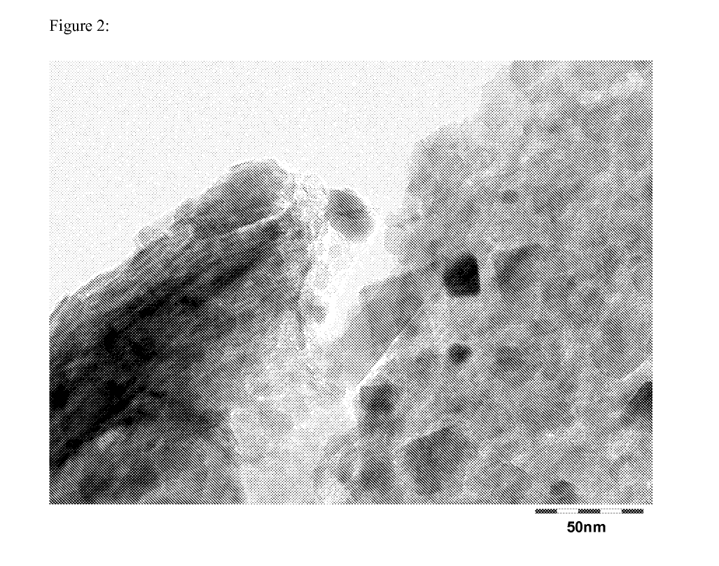

The same process steps as in Example 1 are carried out, with the exception that Plural MG 63 ABSA having a layer spacing of 1.7 nm from Sasol Deutschland GmbH was used as hydrotalcite material. This material comprises 63% by weight of MgO and 37% by weight of Al₂O₃. To increase the spacing between the individual hydrotalcite layers from 0.7 nm to 1.7 nm, meta-aminobenzenesulphonic acid was added during the production of the hydrotalcite. The material obtained after carbonization is completely black because it has a higher proportion of carbon compared to the material obtained in Example 1. This is attributable to the significantly greater layer spacing of the hydrotalcite material into which more graphene can intercolate. The transmission electron micrograph of FIG. 2 shows a structure similar to that in FIG. 1.

1. A composite of one or more layered double hydroxides or sheet silicate and polyacrylonitrile which has been at least partially decomposed into one or more graphene layers and has a relative proportion by mass of nitrogen of less than 20% based on the relative molecular mass of polyacrylonitrile.

2. A composite of one or more layered double hydroxides and polyacrylonitrile which has been at least partially decomposed into one or more graphene layers.

3. A composite according to claim 1, wherein said composite comprises at least one layered double hydroxide selected from the group consisting of hydrotalcite and compounds having a hydrotalcite-like structure.

4. A composite according to claim 3, wherein said hydrotalcite has the formula M2x2+M23+(O)(4x+4)/2, where M2x2+ is a divalent metal selected from the group consisting of Mg, Zn, Cu, Ni, Co, Mn, Ca and Fe; M23+ is a trivalent metal selected from the group consisting of Al, Fe, Co, Mn, La, Ce and Cr and x is a number from 0.5 to 10 in intervals of 0.5.

5. A composite according to claim 2, wherein said layered double hydroxides have a layer spacing of from 0.5 to 2.5 nm.

6. A process for producing a composite having one or more graphene layers, in which acrylonitrile is first added to a layered double hydroxide or sheet silicate, the acrylonitrile is then polymerized to polyacrylonitrile and the polyacrylonitrile is subsequently at least partially decomposed into one or more graphene layers by calcination so as to form a composite having a relative proportion by mass of nitrogen of less than 20% based on the relative molecular mass of polyacrylonitrile.

7. A process for producing a composite having one or more graphene layers, in which acrylonitrile is first added to a layered double hydroxide, the acrylonitrile is then polymerized to polyacrylonitrile and the polyacrylonitrile is subsequently at least partially decomposed into one or more graphene layers by calcination.

8. The process for producing a composite having one or more graphene layers according to claim 6, wherein said calcination step comprises a temperature increase, optionally comprising a stepwise temperature increase, to from 200° C. to 500° C. to stabilize the polyacrylonitrile and a subsequent temperature increase to at least 800° C. to at least partially decompose polyacrylonitrile into said one or more graphene layers.

9. The process for producing a composite having one or more graphene layers according to claim 7, wherein said calcination step comprises a temperature increase, optionally a stepwise temperature increase, to from 200° C. to 500° C. to stabilize the polyacrylonitrile and a subsequent temperature increase to at least 700° C. to at least partially decompose polyacrylonitrile into said one or more graphene layers.

10. The process for producing a composite having one or more graphene layers according to claim 6, wherein said acrylonitrile is added together with a polymerization initiator to said layered double hydroxide or to said sheet silicate.

11. A composite having one or more graphene layers produced by said process according to claim 6.

12. The process for producing one or more graphene layers by acid or alkali treatment of said composite having one or more graphene layers according to claim 1.

13. A composite having one or more graphene layers according to claim 1 and/or a composite capable of being used for producing said one or more graphene layers.
